(19) United States
(12) Patent Application Publication
(10) Pub. No.: US 2024/0306561 A1
(43) Pub. Date: Sep. 19, 2024

(54) PLANT DOCK

(71) Applicants: Driola Hoti, Peachtree City, GA (US); Erica Bourque, Peachtree City, GA (US)

(72) Inventors: Driola Hoti, Peachtree City, GA (US); Erica Bourque, Peachtree City, GA (US)

(21) Appl. No.: 18/607,022

(22) Filed: Mar. 15, 2024

Related U.S. Application Data
(60) Provisional application No. 63/452,237, filed on Mar. 15, 2023.

(51) Int. Cl. A01G 13/00; A01G 9/02

(52) U.S. Cl. CPC A01G 13/00; A01G 9/028

(57) ABSTRACT

A plant dock for growing plants, the plant dock including a container portion and a buoyant portion positioned at the base of the container portion. The container portion includes a base, a plurality of walls positioned at the base, each wall including a first end positioned and the base and a second end positioned opposite the first end, a partially enclosed volume defined by the plurality of walls and the base, and at least one divider positioned at the base and configured to divide the volume into a first volume and a second volume. The buoyant portion includes at least one buoyancy element, and a net coupled to the container portion and configured to contain the at least one buoyancy element. The buoyant portion is configured to maintain the plurality of walls above a liquid surface level when the plant dock is positioned within a liquid.

### FIELD OF INVENTION

The field of invention relates to plant dock for preventing damage to plants, such as crops, that would otherwise occur as a result of flooding.

### BACKGROUND

By some studies, floods account for 19% of crop loss, resulting in the destruction of agricultural products valued at 21 billion USD, damaging both the economy and society between 2008 to 2018. For example, millions of children have perished from malnutrition in Bangladesh alone as a result of devastating flooding. For civilization to advance and develop in the future, this problem needs to be addressed. Disclosed solutions were developed in part to prevent damage to crops and/or plants that may occur as a result of flooding.

### SUMMARY

The terms “invention,” “the invention,” “this invention” and “the present invention used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary provides a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, a or all drawings, and each claim.

Some embodiments of the present technology relate to a plant dock for growing plants, the plant dock including: a container portion including: a base; a plurality of walls positioned at the base, each wall including a first end positioned and the base and a second end positioned opposite the first end; a partially enclosed volume defined by the plurality of walls and the base; and at least one divider positioned at the base and configured to divide the volume into a first volume and a second volume; and a buoyant portion positioned at the base of the container portion, the buoyant portion including: at least one buoyancy element; and a net coupled to the container portion and configured to contain the at least one buoyancy element; wherein the buoyant portion is configured to maintain the second end of each wall of the plurality of walls above a liquid surface level when the plant dock is positioned within a liquid.

Some embodiments of the present technology relate to a plant dock for growing plants, the plant dock including: a container portion including: a base; a plurality of walls positioned at the base, each wall including a first end positioned and the base and a second end positioned opposite the first end; a partially enclosed volume defined by the plurality of walls and the base; and at least one divider positioned at the base and configured to divide the volume into a first volume and a second volume; and a buoyant portion positioned at the base of the container portion, the buoyant portion including: a volume partially enclosed by a base and a series of walls, wherein the buoyant portion is configured to encapsulate a pocket of gas within the volume; wherein the buoyant portion is configured to maintain the second end of each wall of the plurality of walls above a liquid surface level when the plant dock is positioned within a liquid.

Some embodiments of the present technology relate to a plant dock for growing plants, the plant dock comprising: a container portion including: a base; a plurality of walls positioned at the base, each wall including a first end positioned and the base and a second end positioned opposite the first end; a partially enclosed volume defined by the plurality of walls and the base; at least one divider positioned at the base and configured to divide the volume into a first volume, a second volume, a third volume, and a fourth volume; and a plurality of drainage holes positioned within at least one wall of the plurality of walls, wherein the base includes at least one sloped portion which extends outward from a center of the base and is configured to encourage liquid present within the partially enclosed volume towards the plurality of drainage holes; and a buoyant portion positioned at the base of the container portion, the buoyant portion including: at least one buoyancy element; and a net coupled to the container portion and configured to contain the at least one buoyancy element; wherein the buoyant portion is configured to maintain the second end of each wall of the plurality of walls above a liquid surface level when the plant dock is positioned within a liquid.

### BRIEF DESCRIPTION OF THE DRAWINGS

The disclosure will be readily understood by following the detailed description in conjunction with the accompanying drawings, in which:

FIG. 1 depicts a perspective view of one embodiment of a plant dock, in accordance with certain embodiments.

FIG. 2 depicts a perspective view of a second embodiment of the plant dock, in accordance with certain embodiments.

FIG. 3 depicts an exploded view of a third embodiment of the plant dock, in accordance with certain embodiments.

### DETAILED DESCRIPTION

Disclosed solutions relate to plant docks for preventing damage to plants such as crops that would otherwise occur as a result of flooding. By some studies, floods account for 19% of crop loss, resulting in the destruction of agricultural products valued at 21 billion USD, damaging both the economy and society between 2008 to 2018. For example, millions of children have perished from malnutrition in Bangladesh alone as a result of devastating flooding. For civilization to advance and develop in the future, this problem needs to be addressed. Disclosed solutions were developed in part to prevent damage to crops and/or plants that may occur as a result of flooding.

The subject matter of embodiments of the present invention is described here with specificity to meet statutory requirements, but this description is not intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Each example is provided by way of illustration and/or explanation, and not as a limitation. For instance, features illustrated or described as part of one embodiment may be used on another embodiment to yield a further embodiment. Upon reading and comprehending the present disclosure, one of ordinary skill in the art will readily conceive many equivalents, extensions, and alternatives to the specific designs described within, all of which are within the scope of embodiments herein.

In the following description, positional terms like “above,” “below,” “vertical,” “horizontal,” “bottom,” “top,” and the like are sometimes used to aid in explaining and specifying features illustrated in the figures as presented, that is, in the orientation in which labels of the figures are read normally.

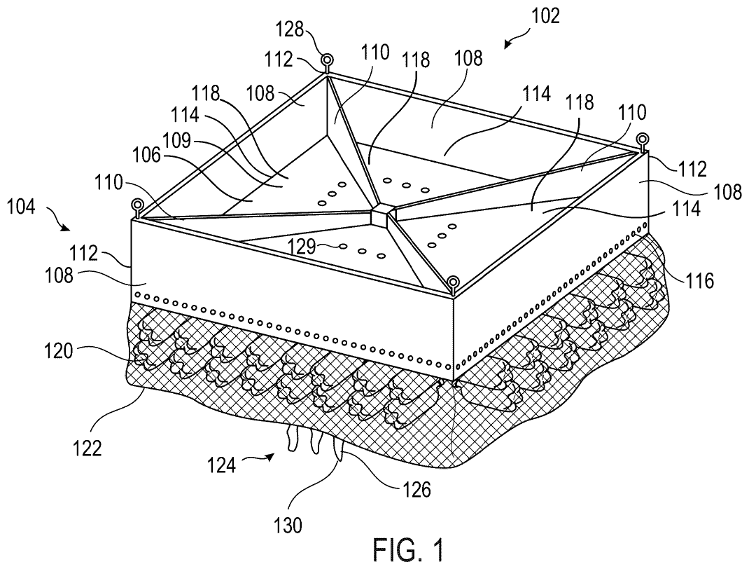

Turning now to the Figures, FIG. 1 depicts a perspective view of one embodiment of a plant dock 100, in accordance with certain embodiments. The plant dock generally includes an upper portion, or container, portion 102 and a lower, or buoyant portion 104. The container portion 102 may generally configured to house plants and other materials, such as substrate, necessary for growing the plants. The container portion 102 includes a base 106 and a plurality of walls 108 extending from the base 106, defining a planting area 109. Furthermore, the container portion 102 is depicted as boxed shaped; however, this is merely exemplary, and the container portion 102 may take a variety of shapes and sizes including: circular, triangular, etc. The container portion 102 may be made of a variety of recyclable, bio-degradable, and/or bio-based plastics such as Polyactide (PLA), though it is envisioned that other types of plastics or materials may be used.

The container portion 102 generally includes a set of dividers 110 which, as shown in FIG. 1, extend from the corners 112 of the container portion 102, dividing the planting area 109 of the container portion 102 into four individual cells 114. In some embodiments, the dividers 110 may additionally provide structural strength to the container portion 102. Each individual cell 114 may house the same or different plants as the neighboring cells 114. Therefore, a singular container portion 102 may be used to grow a variety of plants.

Further, the isolated nature of each cell 114 provides additional safety from flooding, to explain, if one cell 114 is compromised by the flooding, the neighboring cells 114 may still be intact. The dividers 110 are depicted as being generally linear and extending from the corners 112 of the container portion 102, creating four individual cells 114, however, this is merely exemplary and a variety of differing shapes, number of cells 114, and positions of the dividers 110 are envisioned within the scope of this disclosure.

Additionally, in some embodiments, a series of drainage holes 116 may be further positioned around the perimeter of the base 106 or within the side walls 108 of the container portion 102, so as to allow for water or other liquids that are intentionally or unintentionally introduced to drain from or escape the container portion 102. In some embodiments, the drainage holes 116 may be filled with one-way valves to only allow fluid out of the container portion 102 and not into the container portion 102. Furthermore, the drainage holes 116 are depicted within the figures as being a uniform size and spacing, however, this is merely exemplary, and it is envisioned that the size and positioning of the drainage holes 116 may be varied. To encourage excess water to travel towards the drainage holes 116, the base 106 may additionally include a series of four sloped-triangular portions 118 which extend outward from the center of the base 106.

Still in reference to FIG. 1, the buoyant portion 104 may be configured to lift the container portion 102 above a water level in the event of a flood. In particular, the buoyant portion 104 may use a series of buoyant members 120 which may incorporate pockets of air that, when exposed to water, provides enough buoyancy to lift the container portion 102. For example, the buoyant portion 104 may be positioned beneath or adjacent to the container portion 102 and may be configured to provide sufficient buoyancy to keep the container portion 102 sufficiently above the surface of the water and, subsequently, keeping the contents of the container portion 102 sufficiently dry.

As noted above, the buoyant members 120 may be configured to contain an air pocket or a plurality of air pockets which may provide the sufficient buoyancy to support the container portion 102. In some embodiments, to secure the buoyant members 120 to the container portion 102, a containment structure 122 (i.e., netting, roping, etc.) may be incorporated within the plant dock 100. For example, a plurality of bottles (i.e., soda bottles, water bottles, etc.) or other containers may be gathered and positioned within the containment structure 122. The containment structure 122 may then be secured to the base 106 of the container portion 102 such that the buoyant members 120 may be sufficiently secured to the container portion 102. In some embodiments, alternative buoyant members 120 may be used, such as docking, buoys, etc. to provide the necessary buoyancy to the container portion 102. Further, it is envisioned that the buoyant portion 104 may be constructed of all recyclable materials (i.e., fish netting, plastic bottles, etc.) to further reduce the environmental impact of the manufacture, use, and eventual disposal of the plant dock 100. The containment structure 122 and/or buoyant members 120 may be coupled to the container portion 102 at either the base 106 and/or side walls 108 using a variety of attachment methods such as, screws, adhesives, etc.

In some embodiments, the plant dock 100 may additionally include a wicking system 124 which may be configured to provide water to the plants positioned within the container portion 102 in the event of prolonged flooding. In general, the wicking system 124 includes at least one wick 126 which extends downward from the base 106 of the container portion 102. In particular, each wick 126 may include a top portion 129 positioned at or extending upwards from the base 106 and a bottom portion 130 which extends downwards from the base 106. Each wick 126 may soak up any liquid which contacts the bottom portion 103 of the wick 126 through the use of capillary action. Therefore, the wick 126 pulls moisture or liquid from the surrounding environment (i.e. flood water) and transports it to the top portion 129 and into any medium positioned within the container portion 102. The wicking system 124 is a passive system, meaning that there are no moving parts. This approach makes the wicking system 124 an attractive option in the event that the plants may be not watered for an extended period of time, such as in flood conditions. Furthermore, the plant dock 100 may incorporate the wicking system 124 such that the plant dock 100 may be used in situations where the plants grow in flooded environments, such as rice fields, wherein a portion of the wick 126 may be partially submerged for a substantial amount of time. In some embodiments, the wick 126 may be constructed using a fabric wick (i.e., cotton, nylon, etc.).

It is envisioned that, in some embodiments, the plant dock 100 may include a series of hooks 128 positioned at either the base 106 or side walls 108 of the container portion 102 which may be used to couple the plant dock 100 to neighboring plant docks 100. For example, a plurality of plant docks 100 may be positioned adjacent one another and secured to one another forming a cluster. Said cluster provides additional structure and strength to each plant dock 100, providing for each plant dock 100 to withstand the harsh environmental conditions that are often associated with flooding (i.e., dangerous weather, debris, high flow rates, etc.).

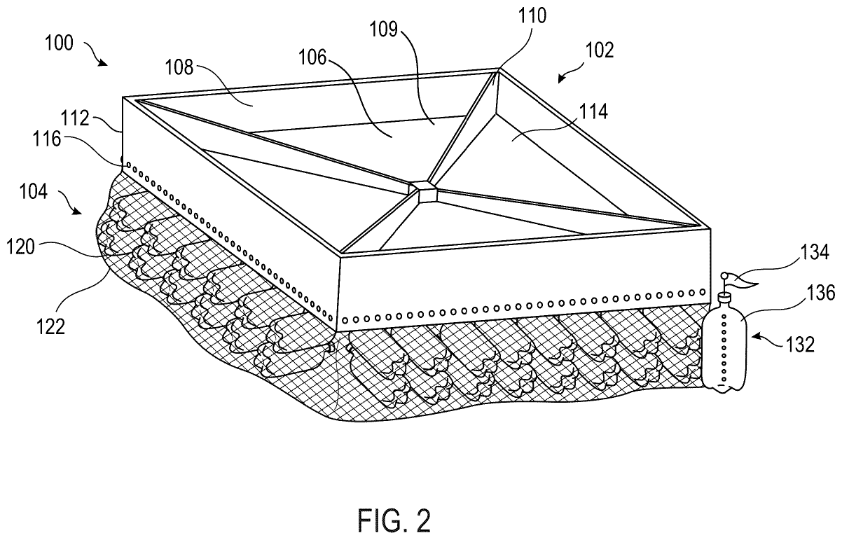

The plant dock 100, as depicted in FIG. 2, may additionally include a flood sensor 132 which indicates whether or not the plant dock 100 is experiencing a heightened water lever. In some embodiments, the flood sensor 132 may use a flag 134 and/or a light to provide a visual indication that the water level has risen passed a specified threshold. The flood sensor 132 may use mechanical or electrical means to detect a rise in the water lever. For example, a cylindrical 136 tube may be filled with a buoyant object so that, as the water level rises, the object will interact with a flag, light, and or/sensor, providing a visual indicator that the plant dock 100 is experiencing abnormal water levels. The described examples of the flood sensor are merely exemplary and any plant dock 100, assembly, or method known in the art may be used to determine flood levels.

In some embodiments, a deployable cover may be positioned above the container portion 102 to protect any plants positioned within the container portion 102 from heavy rains, debris, or other dangers which may potentially damage the plants. In further detail, the deployable cover may incorporate a first cover portion positioned at and hingedly coupled to a first wall of the plurality of walls 108 and a second cover portion positioned at and hingedly coupled to a second wall of the plurality of walls 108. When activated, the first cover portion and the second cover portion may extend towards one another, meeting at a center point above the container portion 102 such that the two portions form a complete cover which may substantially protect the contents of the container portion 102. Prior to being activated, the deployable cover may be configured to be in a retracted position, wherein the first cover portion and the second cover portion are positioned such that they do not substantially cover or interfere with the crops. In some embodiments, the deployable cover may be automatically or manually activated. For example, the deployable cover may be held in the retracted position using springs or other methods known in the art. As the water level rises, the deployable cover may be in electrical or mechanical communication with the flood sensor 132 such that when the water level rises to a particular threshold, the springs may be released such that the first cover portion and the second cover portion are activated and close together as to sufficiently cover the container portion 102.

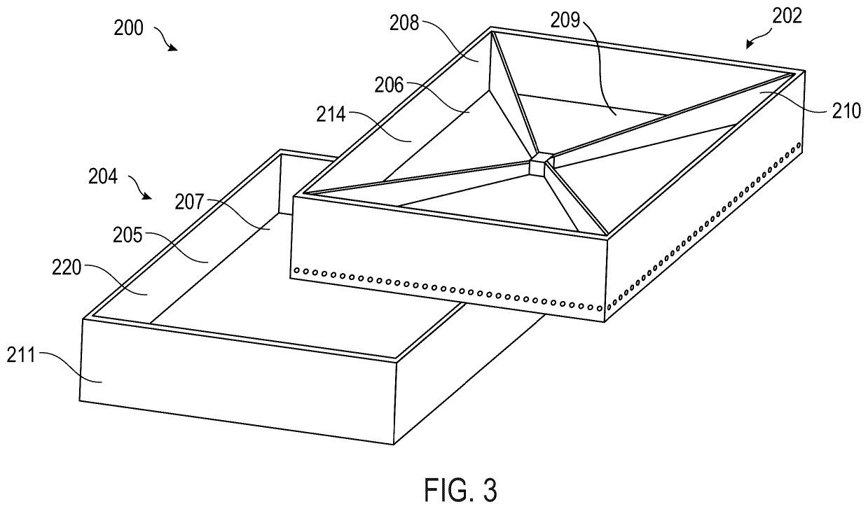

FIG. 3 depicts an exploded view of a second embodiment of a plant dock 200, in accordance with certain embodiments. The plant dock 200 may include an upper, container, portion 202 and a lower, buoyant, portion 204. Similarly to the container portion 202 described in relation to the plant dock depicted in FIG. 1 and FIG. 2, the container portion 202 may be generally configured to house plants and other materials, such as substrate, necessary for growing the plants. The container portion 202 includes a planting area 209 that may be defined by a base 206 and a series of walls 208. Furthermore, the container portion 202 may incorporate a series of dividers 210 to separate the planting area 209 into four individual cells 214. Additionally, it is envisioned that a series of drainage holes 116 may be positioned around the base 206 and/or within the walls 208 of the container portion 202 to allow for water that may be intentionally or unintentionally introduced to the container portion 202 to drain out of the container portion 202.

Similarly as to the embodiments discussed above, the buoyant portion 204 may be configured to lift the container portion 202 above a water level in the event of a flood. In particular and as depicted in FIG. 3, the buoyant portion 204 may incorporate a buoyancy container 220 which encapsulates a pocket of air. As depicted in FIG. 3, the buoyant portion 204 includes a volume 205 enclosed by a base 207 and a series of walls 211. The buoyant portion 204 may then be secured to the container portion 202, sealing a pocket of air within the volume. In an alternative embodiment, a pocket of air may be contained within a vessel such as a plastic bag or other containment method which may then be positioned within the volume providing buoyancy to the plant dock. In such an embodiment, the vessel ensures that the pocket of air will stay intact in the event that the container portion 202 and the buoyant portion 204 are compromised exposing the volume. Therefore, when exposed to water, the pocket of air contained within the within the buoyancy container 220 may provide sufficient buoyancy to lift the container portion 202 substantially above the surface of water. Furthermore, it is envisioned that a portion of or all of the buoyant portion 204 may be constructed of recyclable materials to further reduce the environmental impact of the manufacture, use, and eventual disposal of the plant dock 100.

One potential method for constructing or manufacturing the plant dock depicted in FIG. 1, FIG. 2, and/or FIG. 3 includes: securing the structure of the top portion together (i.e., by using a heat gun); adjusting the base of the container portion such that it is slightly sloped down, to encourage water to flow to the drainage holes; testing the integrity of the container portion; prepare a plurality of water bottles by cleaning, removing any labels, and capping each bottle as to trap air inside (make sure no liquids are inside); positioning each bottle and secure them to one another and/or a fish net using hot glue or a heat gun; constructing a hollow, cylindrical piece; drilling holes through so water can seep into this structure; before sealing, gluing 3 ping-pong balls into a triangular structure and place them inside of the hollow cylindrical piece; adding a flag to the center of the triangular ping-pong ball structure; adding a split come through the top of the flag, completing the warning flag and attaching the flag to the main body; adding soil and plants to the container portion.

The various aspects, embodiments, implementations, or features of the described embodiments can be used separately or in any combination. In particular, it should be appreciated that the various elements of concepts from FIGS. 1-3 may be combined without departing from the spirit or scope of the invention.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, or gradients thereof, unless otherwise indicated herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall results as if absolute and total completion were obtained.

Preferred embodiments of this invention are described herein, including the best mode known to the inventors for carrying out the invention. The invention is susceptible to various modifications and alternative constructions, and certain shown exemplary embodiments there are shown in the drawings and have been described above in detail. Variations of those preferred embodiments, within the spirit of the present invention, may become apparent to those of ordinary skill in the art upon reading the foregoing description. The inventors expect skilled artisans to employ such variations as appropriate, and the inventors intend for the invention to be practiced otherwise than as specifically described herein. Accordingly, it should be understood that there is no intention to limit the invention to the specific form or forms disclosed, but on the contrary, this invention includes all modifications and equivalents of the subject matter recited in the claim appended hereto as permitted by applicable law. Moreover, any combination of the above-described elements in all possible variations thereof is encompassed by the invention unless otherwise indicated herein or otherwise clearly contradicted by context. The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

The subject matter of certain embodiments of this disclosure is described with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

What is claimed is:

1. A plant dock for growing plants, the plant dock comprising:
a container portion including:
a base;
a plurality of walls positioned at the base, each wall including a first end positioned and the base and a second end positioned opposite the first end;
a partially enclosed volume defined by the plurality of walls and the base; and
at least one divider positioned at the base and configured to divide the volume into a first volume and a second volume; and
a buoyant portion positioned at the base of the container portion, the buoyant portion including:
at least one buoyancy element; and
a net coupled to the container portion and configured to contain the at least one buoyancy element;
wherein the buoyant portion is configured to maintain the second end of each wall of the plurality of walls above a liquid surface level when the plant dock is positioned within a liquid.

2. The plant dock of claim 1, wherein a plurality of drainage holes is positioned within at least one wall of the plurality of walls.

3. The plant dock of claim 2, wherein the base includes at least one sloped portion which extends outward from a center of the base and is configured to encourage liquid present within the partially enclosed volume towards the plurality of drainage holes.

4. The plant dock of claim 1, wherein the at least one divider is further configured to divide the volume into a first volume, a second volume, a third volume, and a fourth volume.

5. The plant dock of claim 1, wherein a hook is positioned at at least one wall of the plurality of walls and is configured to secure the plant dock to at least one additional plant dock.

6. The plant dock of claim 1 further comprising a wick, wherein the wick extends through the base and includes a first end positioned above a surface of the base and a second end positioned beneath a surface of the base.

7. The plant dock of claim 1 further comprising a flood sensor secured to the container portion and configured to provide a visual indication that a water level has exceeded a specified threshold.

8. The plant dock of claim 7, wherein the flood sensor provides the visual indication using a light and/or flag.

9. The plant dock of claim 7, wherein the flood sensor comprises a hollow cylindrical tube housing a buoyant object, wherein the buoyant object is configured to travel within a length of the hollow cylindrical tube in response to raising or lowering of the water level.

10. A plant dock for growing plants, the plant dock comprising:
a container portion including:
a base;
a plurality of walls positioned at the base, each wall including a first end positioned and the base and a second end positioned opposite the first end;
a partially enclosed volume defined by the plurality of walls and the base; and
at least one divider positioned at the base and configured to divide the volume into a first volume and a second volume; and
a buoyant portion positioned at the base of the container portion, the buoyant portion including:
a volume partially enclosed by a base and a series of walls, wherein the buoyant portion is configured to encapsulate a pocket of gas within the volume;
wherein the buoyant portion is configured to maintain the second end of each wall of the plurality of walls above a liquid surface level when the plant dock is positioned within a liquid.

11. The plant dock of claim 10, wherein a bag is position within the volume of the buoyant portion and is configured to contain a pocket of gas within the volume.

12. The plant dock of claim 10, wherein a plurality of drainage holes is positioned within at least one wall of the plurality of walls.

13. The plant dock of claim 12, wherein the base includes at least one sloped portion which extends outward from a center of the base and is configured to encourage liquid present within the partially enclosed volume towards the plurality of drainage holes.

14. The plant dock of claim 10, wherein the at least one divider is further configured to divide the volume into a first volume, a second volume, a third volume, and a fourth volume.

15. The plant dock of claim 10, wherein a hook is positioned at at least one wall of the plurality of walls and is configured to secure the plant dock to at least one additional plant dock.

16. The plant dock of claim 10 further comprising a wick, wherein the wick extends through the base and includes a first end positioned above a surface of the base and a second end positioned beneath a surface of the base.

17. The plant dock of claim 10 further comprising a flood sensor secured to the container portion and configured to provide a visual indication that a water level has exceeded a specified threshold.

18. The plant dock of claim 17, wherein the flood sensor provides the visual indication using a light and/or flag.

19. The plant dock of claim 17, wherein the flood sensor comprises a hollow cylindrical tube housing a buoyant object, wherein the buoyant object is configured to travel within a length of the hollow cylindrical tube in response to raising or lowering of the water level.

20. A plant dock for growing plants, the plant dock comprising:
a container portion including:
a base;
a plurality of walls positioned at the base, each wall including a first end positioned and the base and a second end positioned opposite the first end;
a partially enclosed volume defined by the plurality of walls and the base;
at least one divider positioned at the base and configured to divide the volume into a first volume, a second volume, a third volume, and a fourth volume; and
a plurality of drainage holes positioned within at least one wall of the plurality of walls,
wherein the base includes at least one sloped portion which extends outward from a center of the base and is configured to encourage liquid present within the partially enclosed volume towards the plurality of drainage holes; and
a buoyant portion positioned at the base of the container portion, the buoyant portion including:
at least one buoyancy element; and
a net coupled to the container portion and configured to contain the at least one buoyancy element;
wherein the buoyant portion is configured to maintain the second end of each wall of the plurality of walls above a liquid surface level when the plant dock is positioned within a liquid.
